(19) United States
(12) Patent Application Publication
(10) Pub. No.: US 2016/0180983 A1
(43) Pub. Date: Jun. 23, 2016

(54) TRANSPARENT ELECTRODES AND ELECTRONIC DEVICES INCLUDING THE SAME

(71) Applicant: SAMSUNG ELECTRONICS CO., LTD., Suwon-si (KR)

(72) Inventors: Jinyoung HWANG, Seo-gu (KR); Kwanghee KIM, Seoul (KR); Chan KWAK, Gyeonggi-do (KR); Hyeon Cheol PARK, Hwaseong-si (KR); Weonho SHIN, Cheonggyesan-ro (KR); Yun Sung WOO, Yongin-si (KR); Jae-Young CHOI, Suwon-si (KR); Sungjin KIM, Suwon-si (KR); Hyosug LEE, Suwon-si (KR)

(21) Appl. No.: 14/887,915

(22) Filed: Oct. 20, 2015

(30) Foreign Application Priority Data
Dec. 19, 2014 (KR) 10-2014-0184628

(51) Int. Cl. H01B 1/22; H01B 13/00

(52) U.S. Cl. CPC H01B 1/22; H01B 13/0026

(57) ABSTRACT

A transparent electrode including: a substrate; an undercoat disposed on the substrate; a conductive film disposed on the undercoat and including a plurality of conductive metal nanowires and a carboxyl group-containing cellulose; and an overcoat disposed on the conductive film. Also an electronic device including the transparent electrode.

### CROSS REFERENCE TO RELATED APPLICATION

This application claims priority to and the benefit of Korean Patent Application No. 10-2014-0184628, filed in the Korean Intellectual Property Office on Dec. 19, 2014, and all the benefits accruing therefrom under 35 U.S.C. §119, the entire content of which is incorporated herein by reference.

### BACKGROUND

1. Field

A transparent electrode and an electronic device including the same are disclosed.

2. Description of the Related Art

An electronic device, such as a flat panel display such as an LCD or LED, a touch screen panel, a solar cell, a transparent transistor, and the like may include a transparent electrode. The transparent electrode is desirably made of a material having high light transmittance, e.g., a light transmittance of greater than or equal to about 80% in a visible wavelength range, e.g., 400 nanometers (nm) to 800 nm, and low sheet resistance of, for example, less than or equal to 100 ohms per square (ohm/sq), or less than or equal to 50 ohm/sq, preferably when in the form of a thin film.

A currently used material for a transparent electrode is indium tin oxide (ITO). ITO has sufficient transmittance throughout the visible wavelength range, but has a sheet resistance of greater than or equal to 100 ohm/sq at room temperature. In addition, ITO will inevitably cost more due to limited reserves of indium, and is not appropriate for an electrode for a flexible display due to excessive brittleness. Accordingly, development of a material for a flexible transparent electrode having high transmittance and low sheet resistance is needed.

### SUMMARY

An embodiment provides a flexible transparent electrode having high electrical conductivity and excellent light transmittance.

Another embodiment provides an electronic device including the transparent electrode.

In an embodiment, a transparent electrode includes: a substrate; an undercoat disposed on the substrate; a conductive film disposed on the undercoat and including a plurality of conductive metal nanowires and a carboxyl group-containing cellulose (CMC); and an overcoat disposed on the conductive film.

The undercoat may have a refractive index which is greater than a refractive index of the substrate and greater than a refractive index of the conductive film, and the conductive film may have a refractive index which is greater than a refractive index of the overcoat.

The undercoat may have a refractive index of greater than or equal to about 1.65, and the conductive film may have a refractive index of greater than or equal to about 1.50.

The undercoat may have a thickness of greater than or equal to about 150 nm.

At least a portion of the plurality of conductive metal nanowires may be embedded in the carboxyl group-containing cellulose.

The overcoat may comprise, e.g., consist of, a material which is different than the carboxyl group-containing cellulose.

A weight ratio of the carboxyl group-containing cellulose relative to the total weight of the plurality of conductive metal nanowires may range from about 0.5 to about 2.7, and the conductive film may have sheet resistance of less than or equal to about 44 ohms per square.

The conductive film may have haze of less than or equal to about 1.3%.

A number average molecular weight of the carboxyl group-containing cellulose may be greater than or equal to about 10,000 grams per mole, and a degree of substitution of the carboxyl group-containing cellulose may be greater than or equal to about 0.5.

The carboxyl group-containing cellulose may include an alkali metal cation.

The conductive film may have a thickness of about 20 nanometers (nm) to about 150 nm.

The overcoat may consist of a different material than the carboxyl group-containing cellulose.

The overcoat may not include a particle.

In another embodiment, an electronic device including the transparent electrode is provided.

Also disclosed is a method of manufacturing a transparent electrode, the method including: providing a substrate; disposing an undercoat on the substrate; disposing a conductive film on the undercoat, wherein the conductive film includes a plurality of conductive metal nanowires and a carboxyl group-containing cellulose; and disposing an overcoat on the conductive film to manufacture the transparent electrode.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a schematic view showing a cross-section of an embodiment of a transparent electrode; and

FIG. 2 is a cross-sectional view showing a cross-sectional structure of an embodiment of a touch screen panel including an embodiment of a transparent electrode.

### DETAILED DESCRIPTION

Exemplary embodiments will now be described more fully with reference to the accompanying drawings, in which some embodiments are shown. The embodiments, may, however, be embodied in many different forms and should not be construed as being limited to the embodiments set forth herein; rather, these embodiments are provided so that this disclosure will be thorough and complete, and will fully convey the scope of the inventive concepts to those of ordinary skill in the art. Therefore, in some embodiments, well-known process technologies may not be explained in detail in order to avoid unnecessarily obscuring aspects of embodiments. If not defined otherwise, all terms (including technical and scientific terms) in the specification may be defined as commonly understood by one skilled in the art. The terms defined in a generally-used dictionary may not be interpreted ideally or exaggeratedly unless clearly defined. In addition, unless explicitly described to the contrary, the word “comprise” and variations such as “comprises” or “comprising” will be understood to imply the inclusion of stated elements but not the exclusion of any other elements.

Further, the singular includes the plural unless mentioned otherwise.

In the drawings, the thickness of layers, regions, etc., are exaggerated for clarity. Like reference numerals designate like elements throughout the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkali metal” means a metal of Group 1 of the Periodic Table of the Elements, i.e., lithium, sodium, potassium, rubidium, cesium, and francium.

“Rare earth” means the fifteen lanthanide elements, i.e., atomic numbers 57 to 71, plus scandium and yttrium.

The “lanthanide elements” means the chemical elements with atomic numbers 57 to 71.

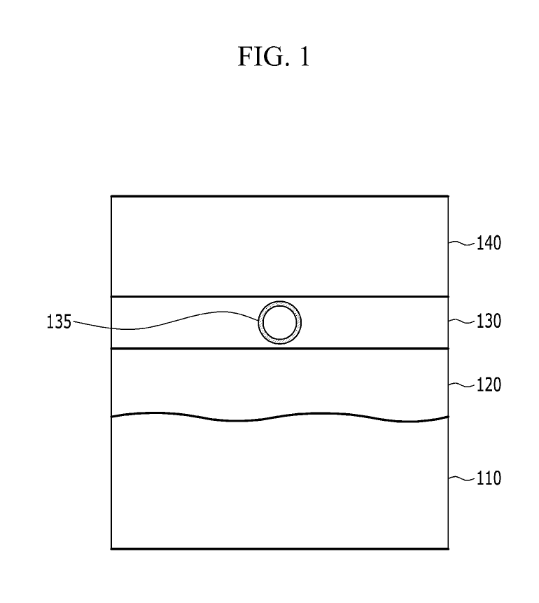

As shown in FIG. 1, a transparent electrode according to an embodiment includes: a substrate 110; an undercoat 120 disposed on the substrate; a conductive film 130 which is disposed on (e.g., directly on) the undercoat and includes a plurality of conductive metal nanowires 135 and a carboxyl group-containing cellulose; and an overcoat 140 disposed on (e.g., directly on) the conductive film.

The substrate may be a transparent substrate. The substrate material is not particularly limited, and may comprise any suitable substrate material, and may comprise a glass, a semiconductor, a polymer, or a combination thereof. Also, the substrate may comprise an insulation layer and/or an electrically conductive film, and the insulation layer and the electrically conductive film may be disposed on one another. As non-limiting examples, the substrate may include an inorganic material such as glass; a polyester such as polyethylene terephthalate, polybutylene terephthalate, and polyethylene naphthalate; polycarbonate; an acryl-based resin; a cellulose or a derivative thereof; a polymer such as a polyimide; an organic/inorganic hybrid material; or a combination thereof. The thickness of the substrate is also not particularly limited, and may be appropriately selected depending upon the configuration of the final product. The substrate may have a thickness of greater than or equal to about 0.5 micrometers (μm), for example, greater than or equal to about 1 μm, greater than or equal to about 10 μm, greater than or equal to about 20 μm, or greater than or equal to about 30 μm, but is not limited thereto. The substrate may have a thickness of less than or equal to about 1 mm, for example, less than or equal to about 500 μm, or less than or equal to about 200 μm, but is not limited thereto. In an embodiment, the substrate may have a thickness of about 0.5 μm to about 500 μm, about 1 μm to about 300 μm, or about 10 μm to about 200 μm.

An undercoat is disposed on the substrate. A surface roughness of the substrate may increase haze of the electrode. Light scattering may be decreased by stacking an undercoat having a refractive index which is greater than the refractive index of the substrate and greater than the refractive index of the conductive film. In an embodiment, the undercoat may have a refractive index of greater than or equal to about 1.65, for example, about 1.70 to about 1.80, and the conductive film may have a refractive index of greater than or equal to about 1.50, for example, about 1.50 to about 1.60. Unless mentioned otherwise, the refractive index is measured at a wavelength within a range of a visible light (i.e., 380 nm to 780 nm) and at room temperature, e.g., 20° C. In an embodiment, the undercoat may have a thickness of greater than about 150 nm. In another embodiment, the undercoat may have a thickness of greater than or equal to about 70 nm, for example, greater than or equal to about 100 nm and less than or equal to about 120 nm, and for example, less than or equal to about 150 nm. In an embodiment, the undercoat has a thickness of about 70 nm to about 150 nm, or about 80 nm to about 125 nm.

The material of the undercoat is not particularly limited as long as it provides the above ranges of the refractive index and the thickness. For example, the undercoat may include various polymers (e.g., poly(meth)acrylate, polyimide, polycarbonate, an epoxy resin, polyurethane, an organosiloxane resin, and the like), various inorganic oxides, or a combination thereof. The inorganic oxide may comprise an oxide of Groups 3 to 13 of the Periodic Table, an oxide of a rare earth element, or a combination thereof. Non-limiting examples of the inorganic oxide may include titanium oxide, aluminum oxide, cerium oxide, yttrium oxide, zirconium oxide, niobium oxide, or antimony oxide. The inorganic oxide may be included in the polymer in a form of nano-sized particles. The nano-sized particles may have a particle size of about 5 nm to about 100 nm, or about 10 nm to about 75 nm, or about 15 nm to about 50 nm. The particle size may be determined by SEM, TEM or light scattering. The polymer may be a cross-linked polymer.

The method of providing an undercoat on a substrate is not particularly limited, and may be appropriately selected according to a substrate material and an undercoat material. For example, a method of forming an undercoat may include preparing a composition including the composed components thereof (e.g., the polymer and/or the inorganic oxide particles or the precursor thereof), coating the same on a substrate, and curing the same. The composition may be coated according to any suitable method, for example, bar coating, blade coating, slot die coating, spray coating, spin coating, gravure coating, inkjet printing, or a combination thereof. The curing conditions may be selected according to a substrate material and an undercoat material. For example, the curing may be performed at a temperature of less than or equal to about 110° C., but is not limited thereto. For example, the curing may be performed by heating and/or ultraviolet (UV) radiation.

A conductive film including a plurality of conductive metal nanowires and a carboxyl group-containing cellulose may be disposed on the undercoat. The conductive film may have a thickness of about 20 nm to about 150 nm, about 30 nm to about hundred 125 nm, or about 40 nm to about 100 nm.

Recently, a transparent electrode has been increasingly desirable for providing a large area display and a flexible touch screen panel. The conductive metal nanowire (for example, a silver nanowire) has high electrical conductivity and a high aspect ratio, so the transparent electrode including the conductive metal nanowire may simultaneously have high electrical conductivity and a high light transmittance. In addition, the transparent electrode may have significantly improved flexibility compared to a transparent electrode based on a transparent conductive oxide (TCO) such as indium tin oxide (ITO).

When the transparent electrode includes an increased amount of a metal nanowire, the electrical conductivity is enhanced (i.e., a sheet resistance is decreased), but the light transmittance is sharply deteriorated by the reflection of the metal (particularly, silver) and absorption. Accordingly, in order to provide as improved transmittance for an improved transparent electrode, the amount of metal nanowire is limited. Also, the metal nanowire-based transparent electrode may have higher haze compared to the metal oxide-based transparent electrode. Without being bound by any particular theory, it is understood that the high haze may be caused by light scattering due to the nanowire and the roughness of the substrate surface, and the refractive index difference between the substrate and air. Due to the high haze, the metal nanowire-based transparent electrode causes problems such as image distortion, conductive pattern visibility, off-state milkiness, and the like in a display panel. On the contrary, the transparent electrode including the undercoat and the conductive film disposed thereon may have suitable sheet resistance and improved light characteristics, such as a combination of high light and low haze).

The conductive metal nanowire included in the conductive film may have a diameter of less than or equal to about 50 nm, for example, less than or equal to about 40 nm, or less than or equal to about 30 nm, or diameter of about 1 nm to about 50 nm, or about 2 nm to about 40 nm. The length of the conductive metal nanowire is not particularly limited, and may be appropriately selected according to a diameter thereof. For example, the conductive metal nanowire may have a length of greater than or equal to about 1 μm, greater than or equal to about 2 μm, greater than or equal to about 3 μm, greater than or equal to about 4 μm, or greater than or equal to about 5 μm, but is not limited thereto. In an embodiment, the conductive metal nanowire may have a length of about 0.5 μm to about 1000 μm, about 1 μm to about 500 μm, about 5 μm to about 250 μm, or about 10 μm to about 100 μm. According to another embodiment, the conductive metal nanowire may have a length of greater than or equal to about 10 μm, for example, greater than or equal to about 11 μm, greater than or equal to about 12 μm, greater than or equal to about 13 μm, greater than or equal to about 14 μm, or greater than or equal to about 15 μm. The conductive metal nanowire may comprise silver (Ag), copper (Cu), gold (Au), aluminum (Al), cobalt (Co), palladium (Pd), or a combination thereof, e.g., an alloy thereof, or a nanometal wire having at least two segments. In an embodiment, the conductive metal nanowire may comprise a transition metal, specifically an element of Groups 3-12, or 4-11, or 10 and 11 of the Periodic Table. The conductive metal nanowire may be fabricated according to any suitable method, and may be a commercially available conductive metal nanowire. The nanowire may include a polymer coating. The polymer coating may comprise polyvinylpyrrolidone, polyoxymethylene, polyvinylnaphthalene, polyetheretherketone, a fluoropolymer, poly-α-methyl styrene, polysulfone, polyphenylene oxide, polyetherimide, polyethersulfone, polyamideimide, polyimide, polyphthalamide, polycarbonate, polyarylate, polyethylenenaphthalate, polyethyleneterephthalate, or combination thereof. A polymer coating comprising polyvinylpyrrolidone is specifically mentioned.

The carboxyl group-containing cellulose may have a number average molecular weight of greater than or equal to about 10,000 grams per mole (g/mol), for example, greater than or equal to about 20,000 g/mol, greater than or equal to about 90,000 g/mol, or greater than or equal to about 200,000 g/mol, or about 10,000 g/mol to about 1,000,000 g/mol, or about 20,000 g/mol to about 800,000 g/mol. The carboxyl group-containing cellulose may have a degree of substitution of greater than or equal to about 0.5, for example, greater than or equal to about 0.6, greater than or equal to about 0.7, greater than or equal to about 0.8, or greater than or equal to about 0.9, or about 0.5 to about 0.99, or about 0.6 to about 0.95, or about 0.7 to about 0.9. In the conductive film, the carboxyl group-containing cellulose may be a salt including an alkali metal cation, e.g., a lithium, sodium, or potassium salt).

For example, in the conductive film, a weight ratio of the carboxyl group-containing cellulose relative to a total weight of the plurality of conductive metal nanowires may be greater than or equal to about 0.5, greater than or equal to about 0.9, greater than or equal to about 1.0, greater than or equal to about 1.1, greater than or equal to about 1.2, greater than or equal to about 1.3, greater than or equal to about 1.4, or greater than or equal to about 1.5. In the conductive film, a weight ratio of the carboxyl group-containing cellulose with respect to a total weight of the plurality of conductive metal nanowires may be less than or equal to about 2.7, for example, less than about 2.7, less than or equal to about 2.5, less than or equal to about 2.4, less than or equal to about 2.3, less than or equal to about 2.1, or less than or equal to about 2.0. In an embodiment, a weight ratio of the carboxyl group-containing cellulose relative to a total weight of the plurality of conductive metal nanowires may be about 0.5 to about 3, or about 0.7 to about 2.5. Within the above range, the conductive film may have low haze while maintaining the high transmittance and the low sheet resistance. For example, the conductive film may have a haze of less than or equal to about 1.3%, for example, less than or equal to about 1.2%, or a haze of about 0.1% to about 1.3%, or about 0.2% to about 1.2%, while having sheet resistance of less than or equal to about 44 ohms per square (ohm/sq), for example, less than or equal to about 40 ohm/sq, less than or equal to about 39 ohm/sq, or less than or equal to about 37 ohm/sq, or about 5 ohm/sq to about 44 ohm/sq, or about 10 ohm/sq to about 40 ohm/sq.

In the transparent electrode according to an embodiment, the conductive film can comprise the carboxyl group-containing cellulose in a substantial amount as set forth above. Generally, the conventional conductive film including the metal nanowires includes an organic binder for binding the nanowiresin order to adjust the viscosity of a composition for forming a conductive filmand increase the binding force between the nanowires. Examples of such anorganic binder may include methyl cellulose, ethyl cellulose, hydroxypropyl methyl cellulose (HPMC), hydroxypropyl cellulose (HPC), xanthan gum, polyvinyl alcohol (PVA), polyvinyl pyrrolidone (PVP), or hydroxyl ethyl cellulose. Most organic binders are known to have an adverse effect on sheet resistance, transmittance, and/or haze of an obtained conductive film. For example, the hydroxypropyl cellulose may reduce conductivity and transmittance, and can increase haze depending on its amount. Also, an organic binder such as xanthan gum may decrease the transmittance and increase the haze, and it also decrease the sheet resistance when being used in a large amount. Accordingly, when the nanowire-based transparent electrode is fabricated, current technology is to use little of the organic binder or removing the organic binder by cleaning or plasma treatment after forming a conductive film on a substrate.

The present inventors have surprisingly found that the transparent electrode including the nanowires disposed in a carboxyl group-containing cellulose provides an improved combination of transmittance and haze, and in an embodiment an improved combination of transmittance, haze, and sheet resistance. For example, when the conductive film includes a carboxyl group-containing cellulose in an amount greater than or equal to about 0.5 time, for example, at greater than or equal to about 0.9 time, even at greater than or equal to about 1 times of the weight of the nanowires, or about 0.5 time to about 10 times, or about 1 time to about 8 times the weight of the nanowires, the conductive film may have improved combination of sheet resistance and light characteristics. In the conductive film, at least a portion, e.g., about 5% to about 90%, or about 10% to about 80%, or about 20% to about 70%, of the conductive metal nanowires may be embedded in the carboxyl group-containing cellulose. In the conductive film, almost all (or in an embodiment all) of the conductive metal nanowires may be embedded in the carboxyl group-containing cellulose. Embedded in the carboxyl group-containing cellulose means that the carboxyl group-containing cellulose closely encloses or surrounds a circumference (e.g., an entire circumference excepting the region contacting the undercoat) of a cross-section cut in a vertical direction to the length of nanowires (refer to: FIG. 1). In this case, the nanowire may be buried in a matrix including the carboxyl group-containing cellulose, for example, through entire length of the nanowire.

The conductive film may be formed on the undercoat by coating a composition including the metal nanowires and a carboxyl group-containing cellulose on the undercoat and removing a solvent. The composition may further include an appropriate solvent (e.g. water, an organic solvent which is miscible or immiscible with water, or the like), selectively a dispersing agent, and selectively an additional organic binder. The type of dispersing agent is not specifically limited, any suitable dispersing agent may be used, such as low molecular weight polyethylene glycols, soya lecithin, sodium dodecyl sulfate, sodium octadecyl sulfate, sodium dodecyl benzene sulfonate, soaps, or a sulfonated mineral oil. The dispersing agent may be included in an amount of 0.01 wt % to about 10 wt %, based on a total weight of the composition. The composition is coated on a substrate, and selectively, dried and/or subjected to heat treatment to provide a conductive film. The composition may be coated according to any suitable method, for example, bar coating, blade coating, slot die coating, spray coating, spin coating, gravure coating, inkjet printing, or a combination thereof. The drying and/or heat treatment may be performed within a temperature range of about 85° C. to about 110° C., or about 90° C. to about 100° C., for a predetermined time, but is not limited thereto. The drying and/or heat treatment may be performed under a nitrogen atmosphere if desired.

An overcoat is disposed on the conductive film to protect the conductive film from mechanical damage due to physical contact and/or contact with the ambient atmosphere (e.g., moisture or air), chemicals, or the like. The overcoat has a lower refractive index than the refractive index of the conductive film. For example, the overcoat may have a refractive index of less than about 1.50, for example, less than or equal to about 1.45 or less than or equal to about 1.40, or a refractive index of 1 to 1.5, or 1.1 to 1.4 or 1.25 to 1.35. Without being bound by any particular theory, the overcoat having the refractive index within the disclosed range is understood to suppress light scattering caused by local surface plasmon resonance of a metal nanowire. The overcoat may have at least one layer, and each additional layer may have the same or a different composition.

The thickness of the overcoat is not particularly limited, and may be selected in accordance with a desired refractive index and a material of the overcoat. For example, the overcoat may have a thickness of greater than or equal to about 50 nm, for example, about 50 nm to about 150 nm, or about 60 nm to about 140 nm, or about 70 nm to about 130 nm, without limitation.

The overcoat may include a second polymer, and the second polymer may be different from the carboxyl group-containing cellulose. In an embodiment the overcoat does not contain the carboxyl group-containing cellulose. In an embodiment, the overcoat may comprise a fluoropolymer, a perfluoropolymer, a (organo)siloxane polymer, a (meth)acrylic resin, or a combination thereof. In an embodiment, the overcoat may include a cross-linked polymer. For example, the cross-linked polymer may be a polymer including a cross-linked (meth)acrylate. In an embodiment, the overcoat may include a crosslinked urethane (meth)acrylate, a perfluoropolymer including a crosslinked (meth)acrylate group, poly(meth)acrylate including a crosslinked (meth)acrylate group, a crosslinked epoxy (meth)acrylate, a cross-linked polymerization product thereof, or a combination thereof. The cross-linked polymerization product may be a photo-cured polymer. The second polymer may be synthesized by any suitable method and may be a commercially available polymer. In an embodiment, the second polymer may include urethane acrylate. The overcoat may further include inorganic oxide particles in order to control a refractive index. In an embodiment, the overcoat does not include particles, such as the inorganic oxide particles.

The overcoat may be formed by coating a composition including the second polymer on the conductive film and curing the same, e.g., by heat treatment or UV irradiation. The coating may be performed according to any suitable method. The curing conditions may be appropriately selected according to the kind of polymer or the like, and is not particularly limited. In a non-limiting example, the curing may be performed at a temperature of about 100° C. to about 110° C. In another embodiment, the curing may be performed by UV irradiation.

The transparent electrode may be applied to provide an electronic device such as a flat or curved display, a touch screen panel, a solar cell, an e-window, an electrochromic mirror, a transparent heater, a heat mirror, a transparent strain sensor, a transparent transistor, or a flexible display. The transparent electrode may be used as a functional glass, or an anti-static layer. In particular, the transparent electrode may be used to provide a flexible electronic device due to its excellent flexibility compared with that of a transparent oxide-based electrode.

The transparent electrode may have a transparency of greater than or equal to about 80%, greater than or equal to about 90%, 80% to 99%, or 85% to 98% in a visible wavelength range, i.e., 400 nanometers (nm) to 800 nm.

The transparent electrode is flexible. In an embodiment, the transparent electrode has a conductivity after being wrapped around a 5 millimeter (mm) rod 180° of greater than about 50%, greater than about 75%, greater than about 90%, about 50% to about 99%, or about 60% to about 98% of a conductivity before being wrapped around the 5 mm rod.

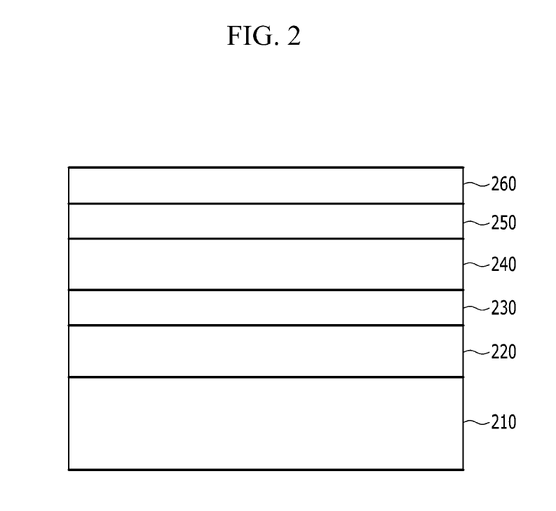

Hereinafter, a touch screen panel as an example of the electronic device is further described. Additional details of the structure of the touch screen panel are known to one of skill in the art, or can be determined by one of skill in the art without undue experimentation, and thus are not further elaborated on herein. The schematic structure of the touch screen panel is shown in FIG. 2. Referring to FIG. 2, the touch screen panel may include a first transparent conductive film 220 on a panel for a display device 210, a first transparent adhesive film 230 (e.g., an optically clear adhesive (OCA) film), a second transparent conductive film 240, a second transparent adhesive film 250, and a window 260 for a display device, on a panel for a display device (e.g., an LCD panel). The first transparent conductive film and/or the second transparent conductive film may be the transparent electrode disclosed herein.

In addition, an example of applying the transparent electrode according to an embodiment to a touch screen panel is illustrated. Further, the transparent electrode may be used as an electrode for other electronic devices including a transparent electrode, without a particular limit. For example, the transparent electrode may be applied as a pixel electrode and/or a common electrode for a liquid crystal display (LCD), an anode and/or a cathode for an organic light emitting diode device, or a display electrode for a plasma display device. In addition, the transparent electrode may be used as a functional glass or an anti-static layer.

Hereinafter, an embodiment is further illustrated in more detail with reference to examples. These examples, however, are not in any sense to be interpreted as limiting the scope of this disclosure.

### EXAMPLES

### Manufacture of Conductive Film and Evaluation

### Reference Examples 1 to 5

### Preparation of Nanowire Dispersion

An aqueous dispersion including silver nanowires (Manufacturer: Cambrios Co., Ltd, weight of silver nanowire: 0.5 wt %, average diameter of silver nanowire: 20-35 nm, average length: 15-30 um) is prepared. An aqueous solution (concentration: 0.5 wt %, Manufacturer: Sigma-Aldrich) of carboxyl methyl cellulose (CMC, sodium salt, number average molecular weight: 250,000, degree of substitution: 0.9) is prepared. The aqueous dispersion is mixed with the CMC aqueous solution, and the mixed solution of water and ethanol (water:ethanol=70 volume:30 volume) is prepared and diluted to a concentration of about 0.1 to about 0.2 wt % to provide a nanowire aqueous dispersion. In the aqueous dispersion, the weight ratios of the nanowire to CMC (CMC(wt)/AgNW(wt)) in the dispersions are 0.1 (Reference Example 1), 0.5 (Reference Example 2), 1.0 (Reference Example 3), 2.0 (Reference Example 4), and 2.7 (Reference Example 5).

### Comparative Reference Examples 1 and 2

A nanowire aqueous dispersion is prepared in accordance with the same procedure as in Reference Examples 1 to 5, except that hydroxypropyl methylcellulose (HPMC, hydroxypropyl 7-12%, Product name: HPMC, Manufacturer: Sigma-Aldrich) aqueous solution (concentration: 0.5 wt %) is used instead of carboxylmethyl cellulose (CMC, sodium salt, number average molecular weight: 250,000, degree of substitution: 0.9).

In the aqueous dispersion, the weight ratios of the nanowire to HPMC (HPMC(wt)/AgNW(wt)) are 2.0 (Comparative Reference Example 1) and 1.0 (Comparative Reference Example 2).

### Comparative Reference Example 3

A nanowire aqueous dispersion is prepared in accordance with the same procedure as in Reference Examples 1 to 5, except that a hydroxypropyl methylcellulose (Methocel J, hydroxypropyl 27%, Manufacturer: Dow Chemical) aqueous solution (concentration: 0.5 wt %) is used instead of carboxylmethyl cellulose (CMC, sodium salt, number average molecular weight 250,000, degree of substitution: 0.9).

In the aqueous dispersion, the weight ratio of nanowire to Methocel J (Methocel J (wt)/AgNW(wt))=2.0.

### Comparative Reference Examples 4 to 6

### Preparation of Nanowire Dispersion

A nanowire aqueous dispersion is prepared in accordance with the same procedure as in the reference examples, except that a xanthan gum (Product name: Xanthan Gum, Manufacturer: Sigma-Aldrich) aqueous solution (concentration: 0.5 wt %) is used instead of the carboxylmethyl cellulose (CMC, sodium salt, number average molecular weight 250,000, degree of substitution: 0.9).

In the aqueous dispersion, the weight ratio of the nanowire to xanthan gum (Xanthan Gum(wt)/AgNW(wt)) was=2.0 (Comparative Reference Example 4), 1.0 (Comparative Reference Example 5), and 0.5 (Comparative Reference Example 6).

### Comparative Reference Example 7

A nanowire aqueous dispersion is prepared in accordance with the same procedure as in the reference examples, except that a pectin (Product name: Pectin, Manufacturer: Sigma-Aldrich) aqueous solution (concentration: 0.5 wt %) was used instead of carboxylmethyl cellulose (CMC, sodium salt, number average molecular weight: 250,000, degree of substitution: 0.9).

In the aqueous dispersion, the weight ratio of the nanowire to the pectin (Pectin(wt)/AgNW(wt)) was=2.0.

### Examples 1 to 5

### Manufacture of Conductive Film and Evaluation of Sheet Resistance, Transmittance and Haze Thereof

The nanowire dispersions according to Reference Examples 1 to 5 are coated on a polyethylene terephthalate (PET) or polycarbonate (PC) substrate, dried with hot air at 90° C., and dried in an oven at 100° C. to provide conductive films according to Examples 1 to 5, respectively.

In the conductive film according to Example 1, it is confirmed that CMC may form a layer having a thickness of about 2.5 nm. In the conductive film according to Example 2, it is confirmed that CMC may form a layer having a thickness of about 12.5 nm. In the conductive film according to Example 3, it is confirmed that CMC may form a layer having a thickness of about 25 nm. In the conductive film according to Example 4, it is confirmed that CMC may form a layer having a thickness of about 50 nm. In the conductive film according to Example 5, it is confirmed that CMC may form a layer having a thickness of about 67.5 nm. Accordingly, in the conductive films according to the examples, it is confirmed that at least a portion (or most) of nanowires are embedded in CMC according to the amount of CMC.

Haze and transmittance of the prepared conductive film are measured using a haze meter (NDH-7000SP, Nippon Denshoku), and the results are shown in the following Table 1.

The obtained conductive films are measured for sheet resistance at 24 points of an A4 sheet reference using R-Chek which is a 4-point sheet resistance measurer, and the average value thereof is shown in the following Table 1.

TABLE 1

| | CMC/Ag | Sheet resistance | Transmittance | Haze |
|---|---|---|---|---|
| | weight ratio | (ohm/sq) | (%) | (%) |
| Example 1 | 0.1 | 35 | 89.1 | 1.02 |
| Example 2 | 0.5 | 31 | 89.1 | 1.12 |
| Example 3 | 1.0 | 32 | 89.4 | 1.11 |
| Example 4 | 2.0 | 34 | 90.3 | 1.13 |
| Example 5 | 2.7 | 37 | 90.8 | 1.18 |

From the results of Table 1, it is confirmed that the conductive film including carboxylmethyl cellulose and silver nanowire may have low sheet resistance of less than or equal to 37 ohm/sq, transmittance of greater than or equal to 89%, and haze of less than or equal to 1.2%.

### Comparative Examples 1 to 7

### Manufacture of Conductive Film and Evaluation of Sheet Resistance, Transmittance and Haze Thereof

The nanowire dispersions obtained from Comparative Reference Examples 1 to 7 are coated on a polyethylene terephthalate (PET) or polycarbonate (PC) substrate, dried with hot air at 90° C., and dried in an oven at 100° C. to provide conductive films.

Haze and transmittance of the manufactured conductive films are measured according to the same method as in the examples, and the results are shown in the following Table 2.

TABLE 2

| | Binder/Ag | Sheet resistance | Transmittance | Haze |
|---|---|---|---|---|
| | weight ratio | (ohm/sq) | (%) | (%) |
| Comparative | 2.0 | 29 | 89.2 | 2.59 |
| Example 1 | | | | |
| Comparative | 1.0 | 31 | 88.0 | 2.21 |
| Example 2 | | | | |
| Comparative | 2.0 | 41 | 89.7 | 1.84 |
| Example 3 | | | | |
| Comparative | 2.0 | 38 | 89.6 | 2.02 |
| Example 4 | | | | |
| Comparative | 1.0 | 30 | 88.7 | 1.72 |
| Example 5 | | | | |
| Comparative | 0.5 | 27 | 88.5 | 1.52 |
| Example 6 | | | | |
| Comparative | 2.0 | 50 | 89.6 | 1.79 |
| Example 7 | | | | |

From the results of Table 2, it is confirmed that the conductive films according to the comparative examples have higher sheet resistance or significantly higher haze than the conductive films according to the examples.

### Example 5

### Manufacture of Transparent Electrode

[1] Forming Undercoat

A resin composition (Product name: HAL 2180, Manufacturer: TOK Co., Ltd.) including an acrylic resin, silica nanoparticles, and titanium oxide nanoparticles is prepared as an undercoat composition. The undercoat composition is coated on a polyethylene terephthalate (PET) or a polycarbonate (PC) substrate using an automated bar coater (GBC-A4, GIST), dried at 100° C. for 3 minutes, and irradiated with a UV lamp (wavelength: 365 nm, dose: 800 mJ/cm²) to provide an undercoat on the substrate.

[2] Forming Conductive Film

The nanowire aqueous dispersion obtained from Reference Example 4 is coated on the undercoat using an automated bar coater (GBC-A4, GIST), dried with hot air at 90° C., and dried in an oven at 100° C. to provide a conductive film.

[3] Forming Overcoat

The overcoat composition including an acrylic resin is coated on the conductive film using an automated bar coater (GBC-A4, GIST), and is irradiated by a UV lamp (wavelength: 365 nm, dose: 800 mJ/cm²) to form an overcoat (refractive index: 1.32) on the conductive film, so as to provide a transparent electrode.

[4] It is considered that the obtained transparent electrode has low pattern visibility when patterned. In addition, the obtained transparent electrode is considered to have low haze.

While this disclosure has been described in connection with what is presently considered to be practical exemplary embodiments, it is to be understood that this disclosure is not limited to the disclosed embodiments, but, on the contrary, is intended to cover various modifications and equivalent arrangements included within the spirit and scope of the appended claims.

What is claimed is:

1. A transparent electrode comprising:
a substrate;
an undercoat disposed on the substrate;
a conductive film disposed on the undercoat and comprising a plurality of conductive metal nanowires and a carboxyl group-containing cellulose; and
an overcoat disposed on the conductive film.

2. The transparent electrode of claim 1, wherein the undercoat has a refractive index which is greater than a refractive index of the substrate and greater than a refractive index of the conductive film, and
wherein the refractive index of the conductive film is greater than a refractive index of the overcoat.

3. The transparent electrode of claim 2, wherein the refractive index of the undercoat is greater than or equal to about 1.65, and
wherein the refractive index of the conductive film is greater than or equal to about 1.50.

4. The transparent electrode of claim 1, wherein the undercoat has a thickness of greater than about 150 nanometers.

5. The transparent electrode of claim 1, wherein at least a portion of the plurality of conductive metal nanowires is embedded in the carboxyl group-containing cellulose.

6. The transparent electrode of claim 1, wherein a weight ratio of the carboxyl group-containing cellulose relative to a total weight of the plurality of conductive metal nanowires is about 0.5 to about 2.7, and
wherein the conductive film has sheet resistance of less than or equal to about 44 ohms per square.

7. The transparent electrode of claim 1, wherein the conductive film has a haze of less than or equal to about 1.3 percent.

8. The transparent electrode of claim 1, wherein the carboxyl group-containing cellulose comprises an alkali metal cation.

9. The transparent electrode of claim 1, wherein a number average molecular weight of the carboxyl group-containing cellulose is greater than or equal to about 10,000 grams per mole, and
wherein a degree of substitution of the carboxyl group-containing cellulose is greater than or equal to about 0.5.

10. The transparent electrode of claim 1, wherein the conductive film has a thickness of about 20 nanometers to about 150 nanometers.

11. The transparent electrode of claim 1, wherein the overcoat consists of a material which is different from the carboxyl group-containing cellulose.

12. The transparent electrode of claim 1, wherein the overcoat does not comprise a particle.

13. The transparent electrode of claim 1, wherein the transparent electrode has a haze of less than or equal to about 1.3%.

14. The transparent electrode of claim 1, wherein the transparent electrode has a sheet resistance of less than or equal to about 44 ohms per square and a transparency of a greater than or equal to about 80% in a visible wavelength range.

15. The transparent electrode of claim 14, wherein the transparent electrode has a conductivity after being wrapped around a 5 millimeter rod 180° of greater than about 50%.

16. An electronic device comprising the transparent electrode of claim 1.

17. A method of manufacturing a transparent electrode, the method comprising:
providing a substrate;
disposing an undercoat on the substrate;
disposing a conductive film on the undercoat, wherein the conductive film comprises a plurality of conductive metal nanowires and a carboxyl group-containing cellulose; and
disposing an overcoat on the conductive film to manufacture the transparent electrode.
